(19) United States
(12) Patent Application Publication
(10) Pub. No.: US 2014/0160476 A1
(43) Pub. Date: Jun. 12, 2014

(54) Method and Apparatus for Performing Spectral Classification

(71) Applicant: MASSACHUSETTS INSTITUTE OF TECHNOLOGY, Cambridge, MA (US)

(72) Inventors: Anish Kumar Goyal, Cambridge, MA (US); Thomas Henry Jeys, Lexington, MA (US); Brian M. Tyrrell, Brookline, NH (US); Michael William Kelly, North Reading, MA (US); Edward Charles Wack, Waltham, MA (US)

(73) Assignee: MASSACHUSETTS INSTITUTE OF TECHNOLOGY, Cambridge, MA (US)

(21) Appl. No.: 13/707,810

(22) Filed: Dec. 7, 2012

(51) Int. Cl. G01N 21/55

(52) U.S. Cl. CPC G01N 21/55
USPC 356/402

(57) ABSTRACT

A method and a device useful for identifying or detecting the presence of a material of interest, such as an explosive or a biological contaminant, in a sample is presented herein. The sample is illuminated with electromagnetic radiation at a predetermined set of wavelengths. An example of an illumination source includes a quantum cascade laser (QCL). The radiation reflects from a sample and is detected at pixels of a detector. Examples of the detectors include digital focal plane array (DFPA) cameras. Intensity of the reflected radiation is measured at each illumination wavelength. The pixels can be configured to add weighted intensities of the reflected radiation, the weights of the intensities being based on a predicted optical response value for the sample at the wavelengths of the first set and the second set of wavelengths. Based on the sum of weighted intensities of the reflected radiation, the likelihood that the material is present within the sample is determined. Speed enhancement over conventional multispectral imaging can be >100-fold.

### GOVERNMENT SUPPORT

This invention was made with government support under F48721-05-C-0002 awarded by the U.S. Department of Defense Research and Engineering Enterprise. The government has certain rights in the invention.

### BACKGROUND OF THE INVENTION

Classifying objects within a scene based on their spectral optical response is employed in a wide range of applications, including chemical detection, explosives detection, biomedical imaging, and forensics, which may be of interest to many industries such as chemical processing, pharmaceuticals, medicine, law enforcement, homeland security, and defense.

A conventional method 100 of such classification that relies on multispectral imaging is schematically depicted in FIG. 1. Method 100 relies on obtaining separate images 108, one for each wavelength emitted by an illuminator 102. This approach generates a large amount of data that needs to be digitally processed. This limits the areal coverage rate (ACR) of the system by the readout rate of the camera and the time needed to analyze multi-image spectral cubes representing the data. Furthermore, method 100 is not robust to substantial change in the scene being observed over the time required to read-out all the camera images. Even with current state-of-the-art high-frame-rate cameras and high-speed computers, there are many applications in which the approach shown in FIG. 1 is not fast enough.

### SUMMARY OF THE INVENTION

An embodiment of the present invention is a method and a corresponding system for rapidly classifying objects within a scene based on their respective spectral optical response. The spectral optical response can take the form of either the reflectance spectrum or transmittance spectrum. Among the benefits of the embodiment is that the classification is achieved at rates higher than conventional multispectral imaging techniques. An example embodiment of such a system is based on a multiwavelength quantum cascade laser (QCL) and a digital focal-plane-array (DFPA) camera.

As used herein, “reflectance” of a sample or an object is a fraction of electromagnetic radiation that reflects from the object/sample when this object/sample is illuminated by electromagnetic radiation of a specified wavelength. Reflectance can be computed by dividing the intensity of the reflected electromagnetic radiation by the intensity of the impinging electromagnetic radiation at the specified wavelength. Each value of the reflectance corresponds to a wavelength. Similarly, “transmittance” of a sample or object is the fraction of electromagnetic radiation that is transmitted through the object/sample when this object/sample is illuminated by electromagnetic radiation of a specified wavelength. Transmittance can be computed by dividing the intensity of the transmitted electromagnetic radiation by the intensity of the impinging electromagnetic radiation at the specified wavelength. Each value of the transmittance corresponds to a wavelength. As stated earlier, the “spectral optical response” can take the form of the reflectance, transmittance, or another physical response of the object/sample to optical illumination. In the following, when either the reflectance or transmittance is used in an example, it is understood that the method is more generally applicable to the spectral optical response.

Optical response of a sample or an object depends on the wavelength at which it is illuminated. As used herein, “spectral optical response” (R) is a function that describes the dependence of a value of optical response of the object on the wavelength at which the object/sample is illuminated.

Either reflectance or transmittance of a sample can depend on the wavelength at which it is illuminated. In such cases, “spectral optical response” (R) may refer to either spectral reflectance or spectral transmittance.

As used herein, a “representation” of a spectral response (S) is any form in which spectral optical response can be expressed (e.g., formulaically, graphically or digitally).

In one example embodiment of the present invention, an object or a sample is classified by comparing a representation of the object's (or sample's) spectral optical response to a library that stores samples of representations of spectral optical response of various known objects. By employing a digital focal plane array (DFPA), the representation of spectral optical response of the object being classified is at least partially computed by the pixel array of the DFPA by manipulating (e.g., adding, subtracting, or shifting) signals detected by each pixel. This eliminates the need for computationally expensive image processing. In one example, the representation of spectral optical response of a sample is a sum of weighted values of the optical response of the sample, each value of the optical response corresponding to a wavelength of a set of wavelengths.

In the system example embodiment corresponding to the above-described method, the system comprises an illuminating module, a detector array, and an identifying module. The illuminating module illuminates a sample, and the detector array detects either the reflected or transmitted electromagnetic radiation. The detector, which can be a DFPA camera, includes one or more pixels configured to compute a representation S of spectral optical response R of the sample. The identifying module, which can be a special or a general purpose computer, identifies the sample based on the representation S by, for example, comparing the representation S to a library of representations of various samples.

In another example, the present invention is a method (and corresponding system) for determining a likelihood that a material is present within a sample. The sample is illuminated with electromagnetic radiation emitted at a first set of wavelengths and a second set of wavelengths. The intensity of electromagnetic radiation reflected by the illuminated sample at each wavelength of the first set and the second set of wavelengths is measured at pixels in an array of pixels. The array of pixels can be, for example, a focal plane array of a DFPA camera. The pixels add weighted intensities of the reflected electromagnetic radiation at each wavelength of the first set and the second set of wavelengths, the weights of the intensities being based on a predicted optical response value for the sample at the wavelengths of the first set and the second set of wavelengths. By comparing the sum of weighted intensities of the reflected electromagnetic radiation to a threshold value, the likelihood that the material is present within the sample is determined.

In another example, the present invention is a method (and corresponding system) of identifying a presence of a material within a sample. A sample is illuminated by electromagnetic radiation comprising two or more sets of wavelengths. Electromagnetic radiation reflected from the sample at each wavelength from the sets of wavelengths is detected at an array of detectors. Each detector outputs a sum of weighted optical responses for each wavelength of the sets of wavelengths, at least one weight being a negative number. Based on the value of the sum, the presence of the material within the sample is identified.

In another example, the present invention is a method (and corresponding system) useful in identifying a sample within a sample. The method comprises actively illuminating a sample with electromagnetic radiation at a set of wavelengths; detecting reflected electromagnetic radiation at detectors comprising an array of pixels; for a first wavelength in the set of wavelengths, causing the reflected electromagnetic radiation detected by the pixels to be multiplied by a first weight; and for a second wavelength in the set of wavelengths, causing the reflected electromagnetic radiation detected by the pixels to be multiplied by a second weight, wherein the first and second weights are unequal and are determined at least in part by the pixel.

In another example, the present invention is a system (and corresponding method) implementing a method of identifying a sample. The system comprises an illuminating module configured to emit electromagnetic radiation at a set of wavelengths; a detector configured to detect reflected electromagnetic radiation, the detector comprising an array of pixels configured to compute a weighted sum of measured optical responses of a sample, each optical response measured at a wavelength within the set of wavelengths, wherein at least one weight of the weighted sum is a negative number; and an identifying module configured to identify the sample based on the weighted sum.

In another example, the present invention is a method (and corresponding system) of identifying a presence of a material within a sample. The method comprises actively illuminating a sample by electromagnetic radiation comprising two or more sets of wavelengths; at detectors comprising an array of pixels, detecting electromagnetic radiation reflected from the sample at each wavelength from the sets of wavelengths, causing one or more pixel to compute a sum of weighted detected electromagnetic radiation for each wavelength of the sets of wavelengths, at least one weight being a negative number; and identifying the presence of the material within the sample based on the value of the sum.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views.

The drawings are not necessarily to scale, emphasis instead being placed upon illustrating embodiments of the present invention.

FIG. 1 is a schematic diagram of a spectral imaging method employed by prior art.

FIG. 2 is a schematic diagram illustrating a spectral imaging method employed by an embodiment of the present invention.

FIG. 3A, FIG. 3B and FIG. 3C are plots of reflectivity as a function of wavelength, i.e. spectral optical response R, showing spectral optical response of samples 1, 2 and 3, respectively, at five different wavelengths.

FIG. 3D is a plot of illumination intensity (in arbitrary units) as a function of wavelength at the five wavelength values shown in FIGS. 3A through 3C.

FIG. 3E is a plot of weights (filter coefficients) Aₙ implemented at a DFPA camera as a function of wavelength. The values shown correspond to the five wavelength values shown in FIGS. 3A through 3C.

FIG. 3F is a list of representations S of the spectral optical response R of samples 1, 2, and 3 shown in FIGS. 3A through 3C.

FIG. 4A is a wideband mid-infrared reflectance image of a simulated outdoor scene.

FIG. 4B is a simulated “truth map,” showing a region of chemical contamination to be detected within the scene shown in FIG. 4A.

FIG. 4C is a classification map showing successful detection of the contaminated region shown in FIG. 4B.

### DETAILED DESCRIPTION OF THE INVENTION

A description of example embodiments of the invention follows.

A Digital Focal Plane Array (DFPA) camera is described in U.S. Pat. No. 8,179,296, the teachings of which are incorporated herein by reference in their entirety.

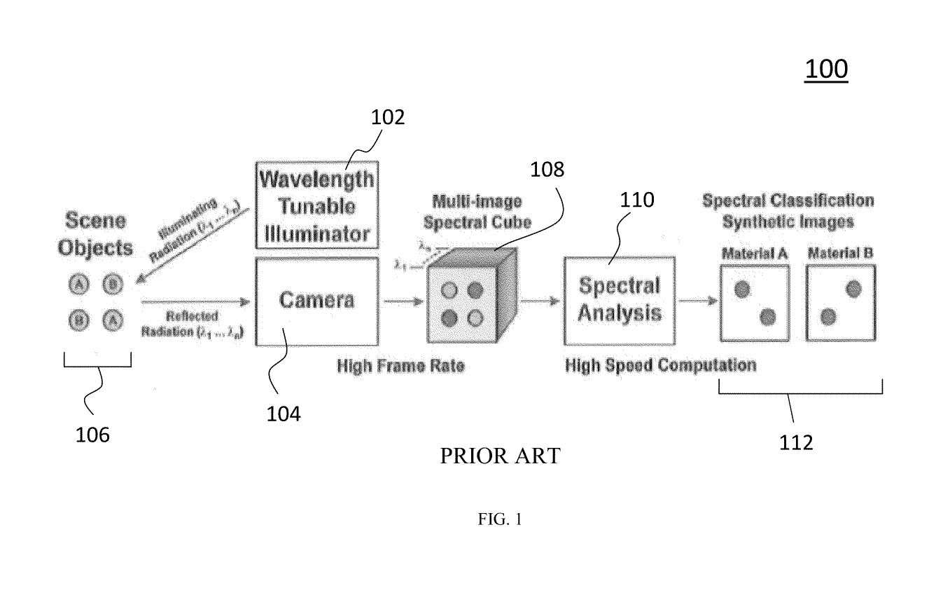

As shown in FIG. 1, prior methods of identifying an object in a scene or a material in a sample by spectral imaging relied on creating a separate image for each wavelength, followed by a computationally expensive image processing. Specifically, method 100 shown in FIG. 1 employs an illuminator 102 emitting a range of wavelengths (λ₁ to λₙ). A scene 106 that includes objects of different materials (e.g., scene objects A and B) is illuminated, and a camera 104 records the optical reflectance of the scene at each illumination wavelength. The resulting multispectral image-cube 108 is analyzed by a spectral analysis module 110 that produces a classification of objects 112.

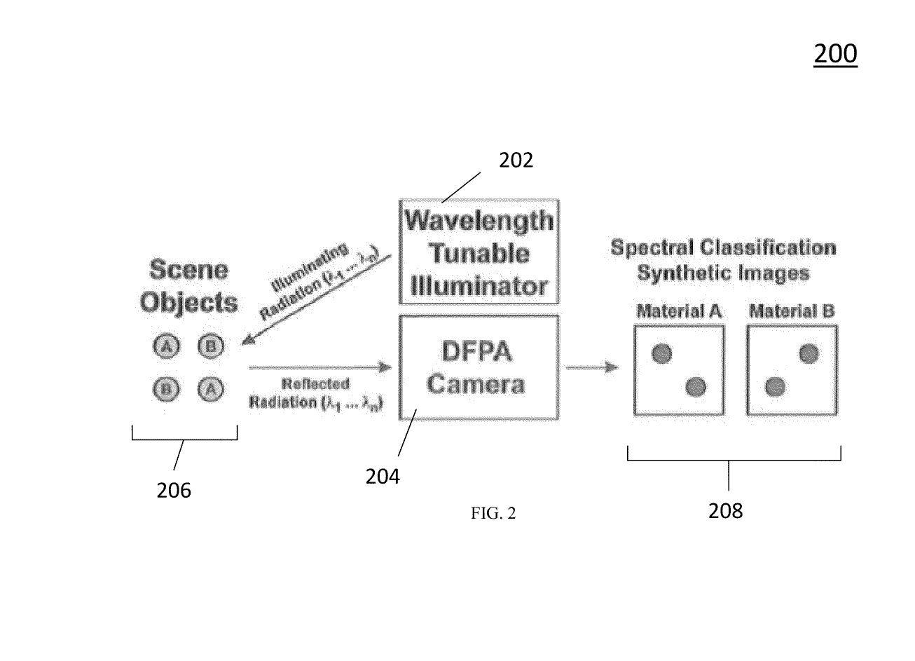

FIG. 2 is a schematic diagram of a system 200 of an embodiment of the present invention. The scene 206, having objects A and B therein, is illuminated by a multiwavelength source 202, also referred to herein as an illuminator, having an emission spectrum such that each image at a focal plane (not shown) of a detector 204 corresponds to combined reflected radiation at multiple wavelengths. The detector 204 can be a digital focal plane array (DFPA) camera, so that images produced by the reflected radiation are then added or subtracted from each other by the detector 204 to result in a classification map 208 that identifies those pixels that correspond to objects of interest.

As used herein, the term “classification map” refers to a single image per class of objects. The value of the classification map for particular objects or samples in the scene is referred to as the “classification score.” The presence of an object or material of interest can be ascertained based on the classification scores within the classification map.

Since each classification map 208 is designed to detect a particular class of objects, classification maps may be generated sequentially for each object class. The frame readout rate is significantly reduced because each classification map replaces an entire multispectral image-cube. A classification map can be generated based on one or a few frame readouts. Also, the computation burden for data analysis is virtually eliminated when compared to the method 100 shown in FIG. 1.

In an example embodiment of the present invention, the illuminator 202 should be wavelength tunable at high speeds, and the detector 204 should incorporate on-chip processing functionality. Examples of such an illuminator 202 include a multiwavelength quantum cascade laser (QCL) array. Other illuminators could include external-cavity tunable QCLs, external-cavity tunable diode lasers, light emitting diodes (LEDs), or any light source that provides wavelength-tunable emission. As mentioned above, an example of a preferred detector 204 is a DFPA camera, but other implementations of a tunable illuminator 202 and detector 204 are contemplated. Alternative detectors that provide variable gain can be used. This includes, for example, image intensified charge-coupled device (CCDs) which can provide variable gain through the image intensification process and electron-multiplying CCDs which incorporate built-in electronic gain.

Quantum cascade lasers (QCLs) are semiconductor lasers that emit in the mid- to terahertz portion of the electromagnetic spectrum. QCL technology is of particular interest because it can access the mid-infrared “molecular fingerprint” spectral region (wavelengths of 3-16 μm). A multiwavelength QCL array comprises individually addressable lasers that span a range of wavelengths. The lasers can be driven simultaneously or sequentially. The wavelength tuning-speed can be extremely fast, and the source can generate an arbitrary optical spectrum by adjusting the power emitted at each wavelength.

The DFPA associates an analog-to-digital converter with each pixel in the focal plane array (FPA). In brief, the DFPA converts photo-current charge generated from a photo-detector into a digital count. This digital count can be added or subtracted to value that is started in a counter that is associated with each pixel. This enables adding or subtracting of the optical signal from the pixel value. Furthermore, since the counter can be enabled or disabled, the DFPA enables functionally such as time-gating of optical signals. Since the pixel count is stored in a digital form, this enables high-speed frame readout and register-shifting of pixel values to adjacent pixels. Combining the QCL array and DFPA camera enables the direct generation of classification maps at very high speeds.

The classification map can be generated by cooperatively operating a QCL array and DFPA camera to implement a representation of the spectral response given by

$$S = {\sum }_{n} {A}_{n} \cdot R ( {λ}_{n} )$$

where the summation is over illumination wavelengths λₙ, R(λₙ) is the spectral optical response of the object, and Aₙ is a weight (also referred to herein as a “filter coefficient”). The filter coefficients are typically chosen to maximize the summation for the target object while suppressing the summation for other objects. In some cases, the classification map is directly given by S. In other cases, multiple representations of the spectral response (S1, S2, etc.) are generated and the classification map is derived from these through computation. In the following, when it is stated that an object/sample is classified based on its representation S, it should be understood that S may have been derived computationally from multiple representations of the spectral response (S1, S2, etc.).

The filter coefficients can be selected based on the prior knowledge of the sample/object being detected. The value of weights Aₙ can be changed or adjusted during the operation of a system of the present invention. With reference to FIG. 2, the values of weights Aₙ can be determined either by the properties of the illuminator 202 or by the functionality of the detector 204. In example embodiments that employ QCL arrays as the illuminator 202 and DFPA cameras as the detector 204, the magnitude of Aₙ can be adjusted by either changing the emission energy of the illuminator 202 at wavelength λₙ (for example, by changing laser peak power, pulse length, or a number of pulses) or by selecting a value of a DFPA receiver gain (e.g., via size of the digital count or “least significant bit”). The sign of Aₙ is determined at the DFPA 204 by either adding or subtracting the signal. In one example embodiment, at least one Aₙ is negative.

Accordingly, in one example embodiment, the present invention is a method, comprising producing reflected electromagnetic radiation by illuminating a sample having spectral optical response R by emitted electromagnetic radiation, the emitted electromagnetic radiation at a set of wavelengths; detecting the reflected electromagnetic radiation by a detector, the detector comprising at least one pixel configured to compute a representation S of spectral optical response R; and causing the at least one pixel to compute the representation S, the representation S being a sum of weighted values of the optical response of the sample, each value of the optical response corresponding to a wavelength of the set of wavelengths. A sample can be identified based on the representation S. In example embodiments, at least one weight in the sum of weighted optical response values is a negative number.

In example embodiments, at least one pixel includes a sensing element configured to generate current when exposed to electromagnetic radiation, and an analog-to-digital converter (ADC) configured to integrate the current generated by the sensing element. The detector can comprise an array of pixels. In an example embodiment, an integration time of the ADC can be varied.

In example embodiments, the first set of wavelengths includes a single wavelength.

In example embodiments, illuminating the sample comprises simultaneously emitting electromagnetic radiation at at least two wavelengths selected from the set of wavelengths. Alternatively, the emission is sequential.

In example embodiments, at least one weight in the sum of weighted optical response values represents intensities of the emitted electromagnetic radiation at wavelengths selected from the set of wavelengths. Alternatively, at least one weight in the sum of weighted optical response values represents an integration period of the at least one pixel. In yet another alternative embodiment, at least one weight in the sum of weighted optical response values represents a number of counts by the at least one pixel.

In example embodiments, the method further includes transmitting representation S to a processing module.

In another example embodiment, at least one weight in the sum of weighted optical response values represents a gain by which to scale a number of counts by the at least one pixel.

In other example embodiments, intensity of emitted electromagnetic radiation can further be varied at a set of wavelengths. The method can further include detecting background electromagnetic radiation. The detected values of the background radiation can be subtracted from the corresponding values of the reflected radiation to improve signal-to-noise ratio and also the dynamic range of the detector. In one example embodiment of the present method, at least one weight is determined by a predicted optical response of the sample at the set of wavelengths.

In another example embodiment, the present invention is a system useful for identifying a sample based on its optical response. The system comprises an illuminating module configured to illuminate a sample having spectral optical response R with emitted electromagnetic radiation to produce reflected electromagnetic radiation, the emitted electromagnetic radiation having a set of wavelengths; a detector configured to detect the reflected electromagnetic radiation, the detector comprising at least one pixel configured to compute a representation S of spectral optical response R, the representation S being a weighted sum of values of the optical response of the sample, each value of the optical response corresponding to a wavelength of the first set of wavelengths; and an identifying module configured to identify the sample based on the representation S. In certain example embodiments, at least one weight is a negative number. The pixels can include a sensing element configured to generate current when exposed to electromagnetic radiation, and an analog-to-digital converter (ADC) configured to integrate the current generated by the sensing element. An example of such pixels are pixels in arrays of a DFPA camera. Examples of an illumination module include a quantum cascade laser.

In another example embodiment, the present invention is a method for determining a likelihood that a material is present within a sample. The method comprises the following operations: illuminating the sample with electromagnetic radiation emitted at a first set of wavelengths and a second set of wavelengths; at pixels in an array of pixels, measuring intensity of electromagnetic radiation reflected by the illuminated sample at each wavelength of the first set and the second set of wavelengths; causing the pixels to add weighted intensities of the reflected electromagnetic radiation at each wavelength of the first set and the second set of wavelengths, the weights of the intensities being based on a predicted optical response value for the sample at the wavelengths of the first set and the second set of wavelengths; and determining the likelihood that the sample is present within the sample by comparing the sum of weighted intensities of the reflected electromagnetic radiation to a threshold value, wherein the sum of weighted intensities of the reflected electromagnetic radiation being above the threshold value signifies the likelihood that the sample is present in the sample.

In another example, the present invention is a method of identifying a presence of a material in a sample or a scene. The method comprises the following operations: illuminating a sample by electromagnetic radiation comprising two or more sets of wavelengths; at detectors within an array of detectors, detecting electromagnetic radiation reflected from the sample at each wavelength from the sets of wavelengths, the radiation representing spectral optical response of the sample at the wavelengths of the sets of wavelengths; causing each detector to output a sum of weighted optical responses for each wavelength of the sets of wavelengths, at least one weight being a negative number; and based on the value of the sum, identifying the presence of the material within the sample. Intensity of emitted electromagnetic radiation can further be varied at a set of wavelengths. In one example embodiment of the present method, at least one weight is determined by a predicted optical response of the sample at the set of wavelengths.

In a further exemplary embodiment, the present invention is a method useful for detecting a material in a sample or a scene. The method comprises actively illuminating a sample with electromagnetic radiation at a set of wavelengths; detecting reflected electromagnetic radiation at detectors comprising an array of pixels; for a first wavelength in the set of wavelengths, causing the reflected electromagnetic radiation detected by the pixels to be multiplied by a first weight; and for a second wavelength in the set of wavelengths, causing the reflected electromagnetic radiation detected by the pixels to be multiplied by a second weight, wherein the first and second weights are unequal and are determined at least in part by the pixel. The method can further comprise causing the pixels to compute a sum of i) a product of the first weight and the detected reflected electromagnetic radiation at the first wavelength and ii) a product of the second weight and the detected reflected electromagnetic radiation at the second wavelength. Additionally, the method can include identifying the sample based on the sum. In an example embodiment of this method, at least one weight is a negative number. Pixels and arrays of pixels employed by this method can include a sensing element configured to generate current when exposed to electromagnetic radiation, and an analog-to-digital converter configured to integrate the current generated by the sensing element.

In example embodiments of this method, illuminating the sample comprises simultaneously emitting electromagnetic radiation comprising at least two wavelengths selected from the set of wavelengths. Alternatively, illuminating the sample can comprise sequentially emitting electromagnetic radiation comprising at least two wavelengths selected from the set of wavelengths.

The weights of the sum can be implemented in a variety of ways. For example, at least one weight in the sum of weighted reflected electromagnetic radiation can be implemented by combining intensities of the emitted electromagnetic radiation. In another example, at least one weight in the sum of weighted reflected electromagnetic radiation is implemented by varying an integration period of the at least one pixel. In another example, at least one weight in the sum of weighted reflected electromagnetic radiation is implemented by performing arithmetic operations in the pixel. In another example, at least one weight represents a gain by which to scale a number of counts by the at least one pixel. These example implementations can be practiced separately or in combination.

In an example embodiment of the above method, the sum is transmitted to a processing module. The processing module can be remote or integrated with the other modules of a system used to practice the above-described method or methods.

An example embodiment of the above-described method further includes determining the likelihood that the material is present within the sample by comparing the sum of weighted intensities of the reflected electromagnetic radiation to a threshold value, wherein the sum of weighted intensities of the reflected electromagnetic radiation being above the threshold value signifies the likelihood that the sample is present in the sample.

In another example, the present invention is a system useful for identifying a material. The system comprises an illuminating module configured to emit electromagnetic radiation at a set of wavelengths; a detector configured to detect reflected electromagnetic radiation, the detector comprising an array of pixels configured to compute a weighted sum of measured optical responses of a sample, each optical response measured at a wavelength within the set of wavelengths, wherein at least one weight of the weighted sum is a negative number; and an identifying module configured to identify the material based on the weighted sum. In an example embodiment, at least one weight is a negative number.

The detector can comprise an array of pixels. Individual pixels and arrays of pixels employed by the above-described system can include a sensing element configured to generate current when exposed to electromagnetic radiation, and an analog-to-digital converter configured to integrate the current generated by the sensing element. The illumination module can include a quantum cascade laser.

In another example, the present invention is a method useful for identifying presence of a material within a sample. The method comprises actively illuminating a sample by electromagnetic radiation comprising two or more sets of wavelengths; at detectors comprising an array of pixels, detecting electromagnetic radiation reflected from the sample at each wavelength from the sets of wavelengths, causing one or more pixels to compute a sum of weighted detected electromagnetic radiation for each wavelength of the sets of wavelengths, at least one weight being a negative number; and identifying the presence of the material within the sample based on the value of the sum.

The methods and systems described herein possess clear advantages when compared to the existing spectral imaging systems and methods.

As an illustration, if 100 different values of wavelengths are used for classification and the radiation is transmitted sequentially at each wavelength with a dwell time of 1 μs per wavelength, then it takes about 100 μs to generate a classification map. This is approximately equal to the time required to read out a single frame from the DFPA (10 kframes/sec for a 256×256 array). As compared to conventional multispectral imaging which requires the readout of 100 frames, the disclosed method results in a speed enhancement of about 100-fold. The enhancement is even higher if the time needed to analyze the multispectral image-cube (108 in FIG. 1) is included.

According to an embodiment of the present invention, part of the reason for the speed improvement as compared to conventional multispectral imaging is that radiation at multiple wavelengths can be transmitted simultaneously as long as they have the same sign for the filter coefficients Aₙ. For instance, all of the wavelengths with positive filter coefficients can be transmitted simultaneously followed by all of the wavelengths with negative filter coefficients. The DFPA then simply performs a single on-chip subtraction. Using a tuning time of 1 μs, the entire classification procedure takes about 2 microseconds. This corresponds to a speed enhancement over conventional multispectral imaging of about 5000-fold. In this case, the areal coverage rate will be limited by the read-out rate of the DFPA, and it may be useful to readout only those pixels that exceed a threshold value to increase the effective frame rate.

When transmitting multiple wavelengths simultaneously, one can use a conventional analog focal plane array (FPA) cameras in which a first frame is exposed with all the positive coefficient wavelengths and a second frame is exposed with all of the negative coefficient wavelengths. The final subtraction is performed off-chip. Instead of reading out 100 frames, this present approach requires the readout of only two frames. Although this present approach is not as efficient as performing the final subtraction on-chip using a DFPA, it nevertheless reduces the high frame rates and amount of off-chip processing that would otherwise be required.

Because the DFPA digital signals can be shifted very rapidly between adjacent pixels, the DFPA digital signals are well suited for the time-delay-integration (TDI) mode of operation in which each pixel tracks an object in the scene while the DFPA camera's field-of-view (FOV) is being scanned. In the context of this invention, TDI can be used in conjunction with spectral filtering by synchronizing each TDI step with one or more laser pulses, and the summation is performed across TDI stages. In this way, the scene can be scanned while simultaneously implementing one or more filter functions. Furthermore, image stabilization can similarly be achieved in combination with spectral filtering.

Beyond TDI, it may be possible to combine spatial and spectral filters to achieved improved classification.

### EXEMPLIFICATION

### Example 1

### Computing Filter Coefficients Aₙ

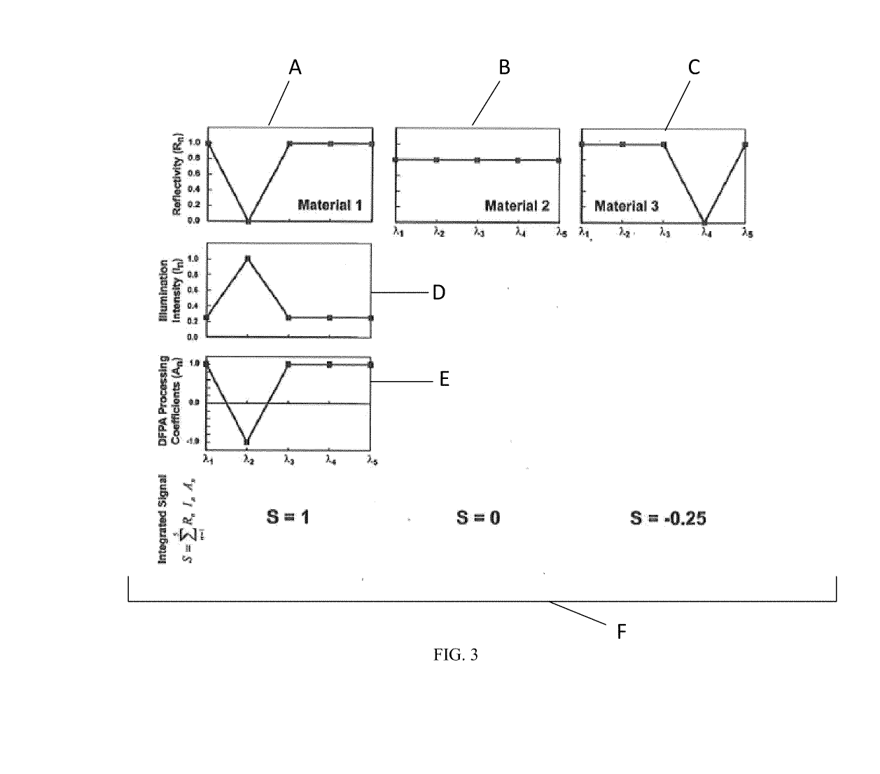

With reference to FIGS. 3A through 3F, sample 1 is distinguished from samples 2 and 3 by appropriate control of the illumination source intensity (illuminator 202 in FIG. 2) and the DFPA operation (the detector 204 in FIG. 2). The spectral reflectance of samples 1 through 3 at five different wavelengths is shown in FIGS. 3A through 3C. Sample 1 has a low reflectivity at wavelength 2, sample 2 has a high reflectivity at all wavelengths, and sample 3 has a low reflectivity at wavelength 4. The average reflectivity, over all wavelengths, is the same for these samples. In this example, the illumination intensity is set to 0.25 (arbitrary units) at wavelength 1 (as shown in FIG. 3D), and the resulting signal on the DFPA is added to the storage buffer behind each pixel, as shown in FIG. 3E. At wavelength 2, the illumination intensity is set to 1 (FIG. 3D), and the signal is subtracted from the buffer at the DFPA (FIG. 3E). At wavelengths 3, 4, and 5, the illumination intensity is set again to 0.25 (FIG. 3D), and these resulting signals are added to the buffer at the DFPA (FIG. 3E). The resulting “representations” of spectral reflectance of each of the three samples are shown in FIG. 3F. After sequentially stepping through all 5 wavelengths, multiplying the detected signal at each wavelength by the respective processing coefficient, and summing the result, pixels that are imaging regions of the sample that contain material 1 have a resultant signal of “1” in their buffer. Pixels that are imaging regions of the sample that contain material 2 have a resultant signal of “0,” and pixels that are imaging regions of the sample that contain material 3 have a resultant signal of “−0.25.” Thus, with only one read-out of the DFPA, the resulting image highlights those parts of the sample that contain material 1. It is possible to extend this example to more complex reflectivity profiles and utilize more sophisticated methods for determining the filter coefficients as described below.

### Example 2

### Simulation of a Complicated Filter Function

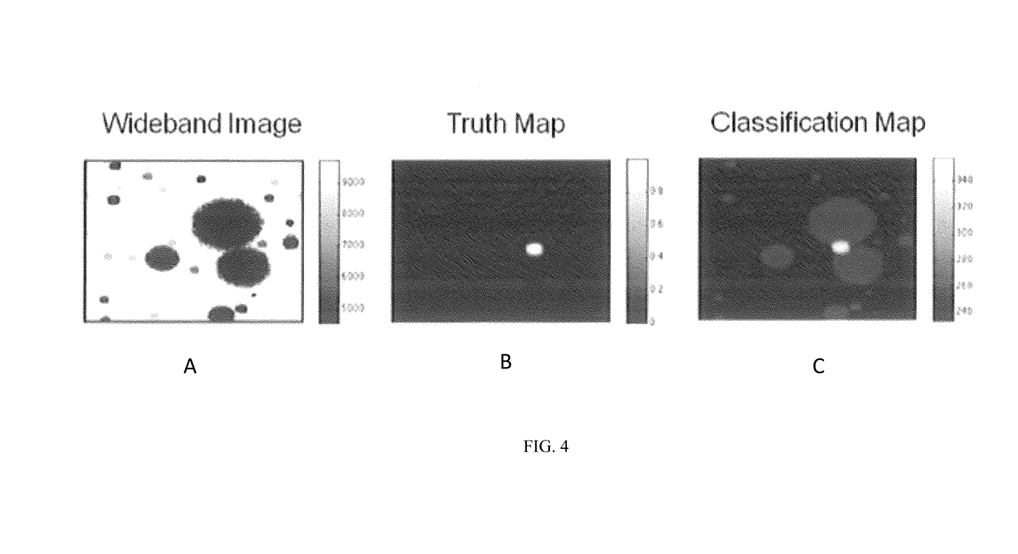

The viability of this technique for more complicated situations is verified through computer simulation. FIG. 4A is a wideband mid-infrared reflectance image of a simulated outdoor scene that contains round concrete slabs that are embedded in sand. FIG. 4B is a simulated “truth map,” showing a region of chemical contamination to be detected. Applying a filter method that utilizes filter coefficients that are determined based on the derivative of the spectral response of the sample to be detected yields a classification map shown in FIG. 4C having maximum classification scores in the contaminated regions.

This simulation confirms that such methods can achieve classification of objects based on their spectral reflectance.

### EQUIVALENTS

While this invention has been particularly shown and described with references to example embodiments thereof, it will be understood by those skilled in the art that various changes in form and details may be made therein without departing from the scope of the invention encompassed by the appended claims.

What is claimed is:

1. A method, comprising:
producing reflected electromagnetic radiation by illuminating a sample having spectral optical response R by emitted electromagnetic radiation, the emitted electromagnetic radiation at a set of wavelengths;
detecting the reflected electromagnetic radiation by a detector, the detector comprising at least one pixel configured to compute a representation S of spectral optical response R; and
causing the at least one pixel to compute the representation S, the representation S being a sum of weighted values of the optical response of the sample, each value of the optical response corresponding to a wavelength of the set of wavelengths.

2. The method of claim 1, further including identifying the sample based on the representation S.

3. The method of claim 1, wherein at least one weight in the sum of weighted optical response values is a negative number.

4. The method of claim 1, wherein the at least one pixel includes:
a sensing element configured to generate current when exposed to electromagnetic radiation, and
analog-to-digital converter (ADC) configured to integrate the current generated by the sensing element.

5. The method of claim 1, wherein the detector comprises an array of pixels.

6. The method of claim 1, wherein the first set of wavelengths includes a single wavelength.

7. The method of claim 1, wherein illuminating the sample comprises simultaneously emitting electromagnetic radiation at at least two wavelengths selected from the set of wavelengths.

8. The method of claim 1, wherein illuminating the sample comprises sequentially emitting electromagnetic radiation at at least two wavelengths selected from the set of wavelengths.

9. The method of claim 1, wherein at least one weight in the sum of weighted optical response values represents intensities of the emitted electromagnetic radiation at wavelengths selected from the set of wavelength.

10. The method of claim 1, wherein at least one weight in the sum of weighted optical response values represents an integration period of the at least one pixel.

11. The method of claim 1, wherein at least one weight in the sum of weighted optical response values represents a number of counts by the at least one pixel.

12. The method of claim 1, further including transmitting representation S to a processing module.

13. The method of claim 1, wherein at least one weight in the sum of weighted optical response values represents a gain by which to scale a number of counts by the at least one pixel.

14. The method of claim 1, further including varying intensity of emitted electromagnetic radiation at a set of wavelength.

15. The method of claim 1, wherein at least one weight is determined by a predicted optical response of the sample at the set of wavelengths.

16. The method of claim 1, wherein electromagnetic radiation is emitted at the set of a sparse sampling of wavelengths from about 2 to about 16 micrometer.

17. The method of claim 4, further comprising varying an integration time of the ADC.

18. The method of claim 1, wherein the spectral optical response is spectral reflectivity.

19. A system, comprising:
an illuminating module configured to illuminate a sample having spectral optical response R with emitted electromagnetic radiation to produce reflected electromagnetic radiation, the emitted electromagnetic radiation having a set of wavelengths;
a detector configured to detect the reflected electromagnetic radiation, the detector comprising at least one pixel configured to compute a representation S of spectral optical response R, the representation S being a weighted sum of values of the optical response of the sample, each value of the optical response corresponding to a wavelength of the first set of wavelengths; and
an identifying module configured to identify the sample based on the representation S.

20. The system of claim 19, wherein at least one weight is a negative number.

21. The system of claim 19, wherein the at least one pixel includes:
a sensing element configured to generate current when exposed to electromagnetic radiation, and
an analog-to-digital converter (ADC) configured to integrate the current generated by the sensing element.

22. The system of claim 19, wherein the detector comprises an array of pixels.

23. The system of claim 19, wherein the illumination module includes a quantum cascade laser.

24. A method for determining a likelihood that a material is present within a sample, the method comprising:
illuminating the sample with electromagnetic radiation emitted at a first set of wavelengths and a second set of wavelengths;
at pixels in an array of pixels, measuring intensity of electromagnetic radiation reflected by the illuminated sample at each wavelength of the first set and the second set of wavelengths;
causing the pixels to add weighted intensities of the reflected electromagnetic radiation at each wavelength of the first set and the second set of wavelengths, the weights of the intensities being based on a predicted optical response value for the sample at the wavelengths of the first set and the second set of wavelengths,
determining the likelihood that the material is present within the sample by comparing the sum of weighted intensities of the reflected electromagnetic radiation to a threshold value, wherein the sum of weighted intensities of the reflected electromagnetic radiation being above the threshold value signifies the likelihood that the sample is present in the sample.

25. A method of identifying a presence of a material within a sample, the method comprising:
illuminating a sample by electromagnetic radiation comprising two or more sets of wavelengths;
at detectors within an array of detectors, detecting electromagnetic radiation reflected from the sample at each wavelength from the sets of wavelengths, the radiation representing spectral optical response of the sample at the wavelengths of the sets of wavelengths;
causing each detector to output a sum of weighted optical responses for each wavelength of the sets of wavelengths, at least one weight being a negative number; and
based on the value of the sum, identifying the presence of the material within the sample.

26. The method of claim 1, further including detecting background electromagnetic radiation.

27. A method, comprising:
actively illuminating a sample with electromagnetic radiation at a set of wavelengths;
detecting reflected electromagnetic radiation at detectors comprising an array of pixels;
for a first wavelength in the set of wavelengths, causing the reflected electromagnetic radiation detected by the pixels to be multiplied by a first weight; and
for a second wavelength in the set of wavelengths, causing the reflected electromagnetic radiation detected by the pixels to be multiplied by a second weight, wherein the first and second weights are unequal and are determined at least in part by the pixel.

28. The method of claim 27, further comprising causing the pixels to compute a sum of
i) a product of the first weight and the detected reflected electromagnetic radiation at the first wavelength and
ii) a product of the second weight and the detected reflected electromagnetic radiation at the second wavelength.

29. The method of claim 30, further comprising identifying a constituent of the sample based on the sum.

30. The method of claim 27, wherein at least one weight is a negative number.

31. The method of claim 27, wherein at least one pixel includes:
a sensing element configured to generate current when exposed to electromagnetic radiation, and
an analog-to-digital converter configured to integrate the current generated by the sensing element.

32. The method of claim 27, wherein illuminating the sample comprises simultaneously emitting electromagnetic radiation comprising at least two wavelengths selected from the set of wavelengths.

33. The method of claim 27, wherein illuminating the sample comprises sequentially emitting electromagnetic radiation comprising at least two wavelengths selected from the set of wavelengths.

34. The method of claim 28, wherein at least one weight in the sum of weighted reflected electromagnetic radiation is implemented by combining intensities of the emitted electromagnetic radiation.

35. The method of claim 28, wherein at least one weight in the sum of weighted reflected electromagnetic radiation is implemented by varying an integration period of the at least one pixel.

36. The method of claim 28, wherein at least one weight in the sum of weighted reflected electromagnetic radiation is implemented by performing arithmetic operations in the pixel.

37. The method of claim 28, further including transmitting the sum to a processing module.

38. The method of claim 27, wherein at least one weight represents a gain by which to scale a number of counts by the at least one pixel.

39. The method of claim 28, further comprising:
determining a likelihood that the sample contains a constituentby comparing the sum of weighted intensities of the reflected electromagnetic radiation to a threshold value, wherein the sum of weighted intensities of the reflected electromagnetic radiation being above the threshold value signifies the likelihood that the constituent is present in the sample.

40. A system, comprising:
an illuminating module configured to emit electromagnetic radiation at a set of wavelengths;
a detector configured to detect reflected electromagnetic radiation, the detector comprising an array of pixels configured to compute a weighted sum of measured optical responses of a sample, each optical response measured at a wavelength within the set of wavelengths, wherein at least one weight of the weighted sum is a negative number; and
an identifying module configured to identify the sample based on the weighted sum.

41. The system of claim 40, wherein at least one weight is a negative number.

42. The system of claim 40, wherein the at least one pixel includes:
a sensing element configured to generate current when exposed to electromagnetic radiation, and
an analog-to-digital converter configured to integrate the current generated by the sensing element.

43. The system of claim 40, wherein the detector comprises an array of pixels.

44. The system of claim 40, wherein the illumination module includes a quantum cascade laser.

45. A method of identifying a presence of a constituent within a sample, the method comprising:
actively illuminating a sample by electromagnetic radiation comprising two or more sets of wavelengths;
at detectors comprising an array of pixels, detecting electromagnetic radiation reflected from the sample at each wavelength from the sets of wavelengths,
causing one or more pixel to compute a sum of weighted detected electromagnetic radiation for each wavelength of the sets of wavelengths, at least one weight being a negative number; and
identifying the presence of the constituent within the sample based on the value of the sum.
